(19) United States
(12) Patent Application Publication
(10) Pub. No.: US 2010/0054488 A1
(43) Pub. Date: Mar. 4, 2010

(54) Apparatus for Testing Hearing Aid Batteries

(76) Inventor: Robby Dale Young, Palm Desert, CA (US)

Correspondence Address: Joseph Curtis Edmondson, 15490 NW Oak Hills Dr, Beaverton, OR, 97006, US

(21) Appl. No.: 12/511,784

(22) Filed: Jul. 29, 2009

Related U.S. Application Data
(60) Provisional application No. 61/085,323, filed on Jul. 31, 2008.

(51) Int. Cl. H04R 25/00; H04R 29/00

(52) U.S. Cl. 381/60; 381/323

(57) ABSTRACT

A caddy for testing hearing aid batteries, including a battery test unit having a battery receiver, a battery test mechanism, and an indicator mechanism displaying the capacity of the battery tested. The caddy further includes a storage compartment for storing hearing aid batteries, and an optional flashlight for assisting with battery replacement.

### RELATED APPLICATIONS

This application claims the benefit of and priority to U.S. Provisional Application Ser. No. 61/085,323 filed Jul. 31, 2008 by Robby Dale Young, the contents of which are hereby incorporated by reference as if recited full herein for all purposes.

### BACKGROUND

The inventive subject matter disclosed herein is directed to a caddy for testing hearing aid batteries that combines the features of testing hearing aid batteries, storing batteries, and providing for a flash light.

A hearing aid is an electro-acoustic body-worn apparatus which typically fits in or behind the wearer's ear, and is designed to amplify and modulate sounds for the wearer. The hearing aid usually has three basic parts: a microphone, amplifier, and speaker. The hearing aid generally receives sound through a microphone, which converts the sound waves to electrical signals and sends them to an amplifier. The amplifier increases the power of the signals and then sends them to the ear through a speaker.

Hearing aids differ in their type of sound processing, available features, and styling. The most common styles include: behind-the-ear (BTE), in-the-ear (ITE), in-the-canal (ITC) and completely-in-the-canal (CIC) hearing aids. Each style allows for different amounts of amplification and adjustability according to its size. For example, because an ITC hearing aid is very small, it is less adjustable and provides only enough amplification for milder hearing losses. The hearings aids are powered by hearing aid batteries, which are commercially available in different sizes. Usually, button-shaped batteries are used because they are compact and have long life. The cylindrical side of these types of batteries is part of the positive terminal. These batteries may be stored in special dispensers, as described, for example, in U.S. Pat. No. 5,129,549 and U.S. Pat. No. 4,153,758.

People using hearing aids depend considerably on the proper use of the hearing device. Therefore, it is vey important to be able to assess the capacity of the hearing aid batteries and to keep handy a supply of replacement batteries at all times. Additionally, there are advantages of having a flashlight available when batteries need to be changed. For example, a flashlight may help the user to see details to install the batteries correctly in circumstances of near darkness, such as in a movie theatre.

Some prior art describes the combination of a flashlight and battery case. For example, U.S. Pat. No. 2,197,314 discloses a housing for using conventional flashlight batteries to supply current to an hearing aid apparatus and also acts as a battery 10 testing device to indicate the condition of the batteries. However, this apparatus uses large cylindrical batteries and does not provide the storage and testing capabilities for button-shaped batteries.

Although consumers can purchase battery testers, battery holders, and flashlights separately, none of the prior art devices combines all functions in one convenient caddy.

Accordingly there is a need for a caddy that is capable of testing any size of commercially available button-shaped hearing aid battery, in combination with storing additional batteries, and optionally providing for a flashlight.

### SUMMARY

These and other embodiments are described in more detail in the following detailed descriptions and the figures.

The inventive subject matter is directed to a caddy for testing hearing aid batteries, the caddy including a battery test unit having a battery receiver, a battery test mechanism, and an indicator mechanism indicating the capacity of the battery tested.

The caddy further includes a storage compartment for storing one or more hearing aid batteries. In the foregoing embodiment, the caddy may and optionally include a flashlight. In the foregoing embodiment, the battery receiver may be a platform adapted to receive one or more button-shaped batteries. The battery receiver platform may further be adapted to place button-shaped batteries with one particular terminal side in a particular direction, for example the plus side of the battery in the up position, and to allow for sliding the battery towards the battery test mechanism, thereby activating the test mechanism and displaying the test result with the indicator mechanism. In the foregoing embodiment, the battery receiver may include a symbol indicating the direction to slide the battery to activate the test mechanism.

In another possible embodiment, a caddy for testing hearing aid batteries may have a casing having a side with an opening for a battery receiver for receiving a hearing aid battery, the receiver allowing the battery to connect with a test mechanism that activates an indicator mechanism indicating the battery capacity. The caddy further may have a storage area, such as a compartment for storing one or more hearing aid batteries, and optionally a flashlight operable from a switch on the front side of the casing. In the foregoing embodiment, the battery receiver may be adapted to place button-shaped batteries with the particular terminal in a particular position, e.g., the plus side of the battery in the up position. It may also allow for sliding of the battery towards the battery test mechanism, thereby activating the mechanism and activating the indicator mechanism. In the foregoing embodiment, the opening for the battery receiver may allow the battery to be tested to move to the edge of the opening to activate the test mechanism. In the foregoing embodiment, the battery receiver may have a symbolindicating the direction in which to slide the battery to activate the test mechanism.

In the foregoing embodiment, the indicator mechanism may have one or more light sources, such as an LED, powered by the battery to be tested. For example different color lights or number of lights, correspond to a level of battery charge. In the foregoing embodiment, the caddy may further include a window showing the light sources. In the foregoing embodiment, the storage compartment may include a slideable drawer dimensioned to store one or more button-shaped hearing aid batteries. For example, the drawer may be dimensioned to fit two AG 5 batteries. In the foregoing embodiment, the caddy may include a flashlight, comprising for example, an LED and a battery.

The inventive subject matter further contemplates a method for making and using such a caddy for testing hearing aid batteries.

The foregoing is not intended to be an exhaustive list of embodiments and features of the inventive subject matter. Persons skilled in the art are capable of appreciating other embodiments and features from the following detailed description in conjunction with the drawings.

### BRIEF DESCRIPTION OF THE DRAWINGS

The following figures show embodiments according to the inventive subject matter, unless noted as showing prior art.

FIGS. 1-2 show left and right perspective views of a disassembled caddy as seen from the front of the caddy.

FIGS. 3-4 show left and right perspective views of a disassembled caddy as seen from the back of the caddy.

FIG. 5 shows a perspective view of the back side of the caddy.

FIG. 6 shows a perspective view of the front side of the caddy.

FIG. 7 shows a front view of the back side of the caddy.

FIG. 8 shows a side view of the caddy.

FIG. 9 shows a front view of the front side of the caddy.

FIG. 10 shows a top view of the top side of the caddy.

FIG. 11 shows a top view of the bottom side of the caddy.

### DETAILED DESCRIPTION

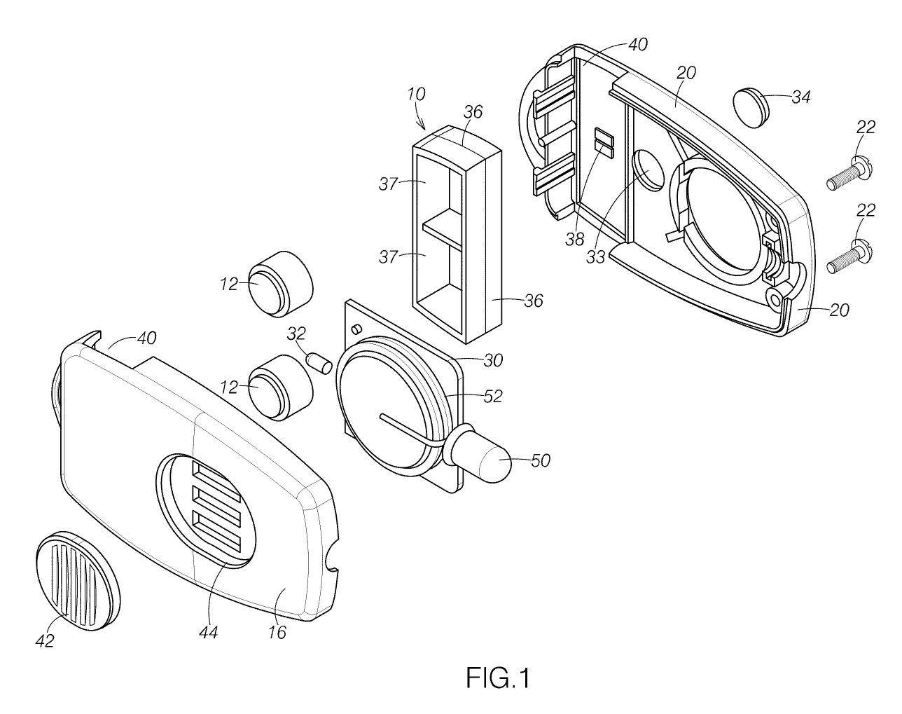

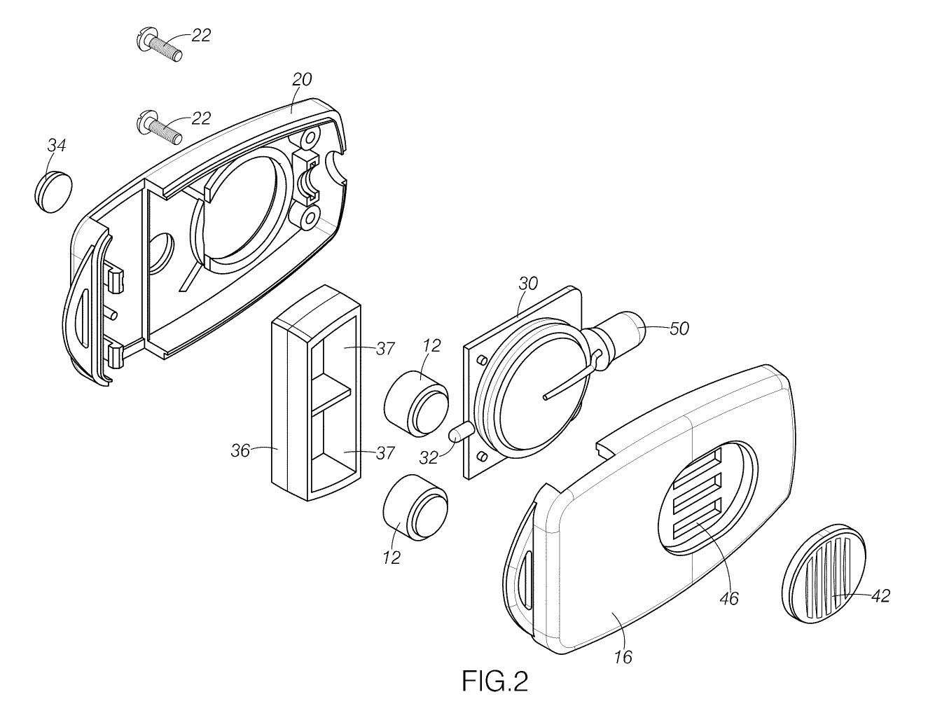

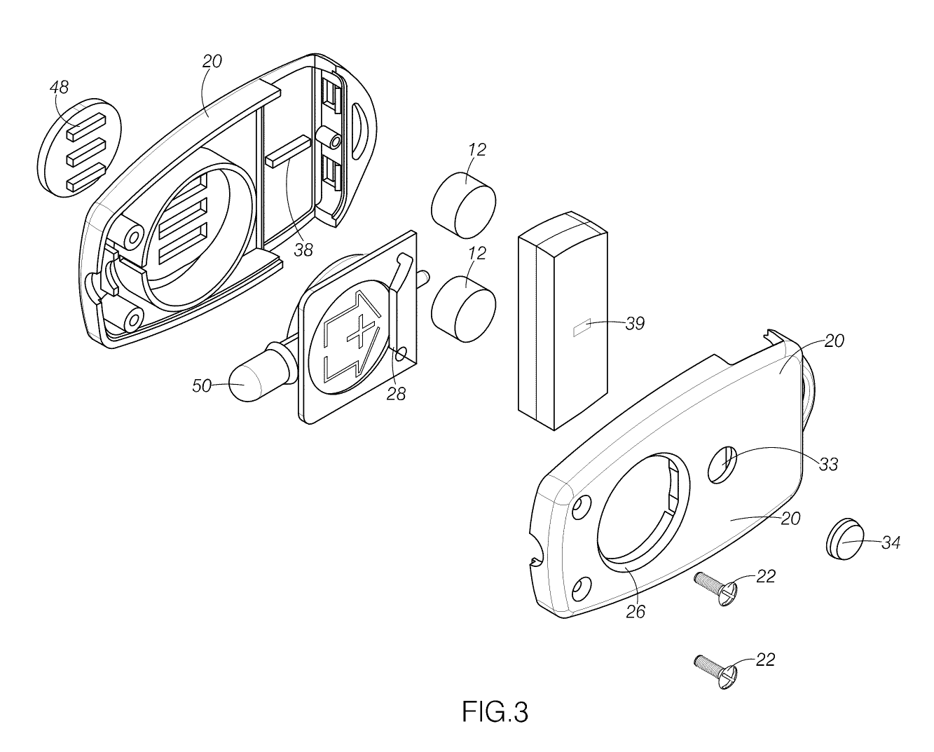

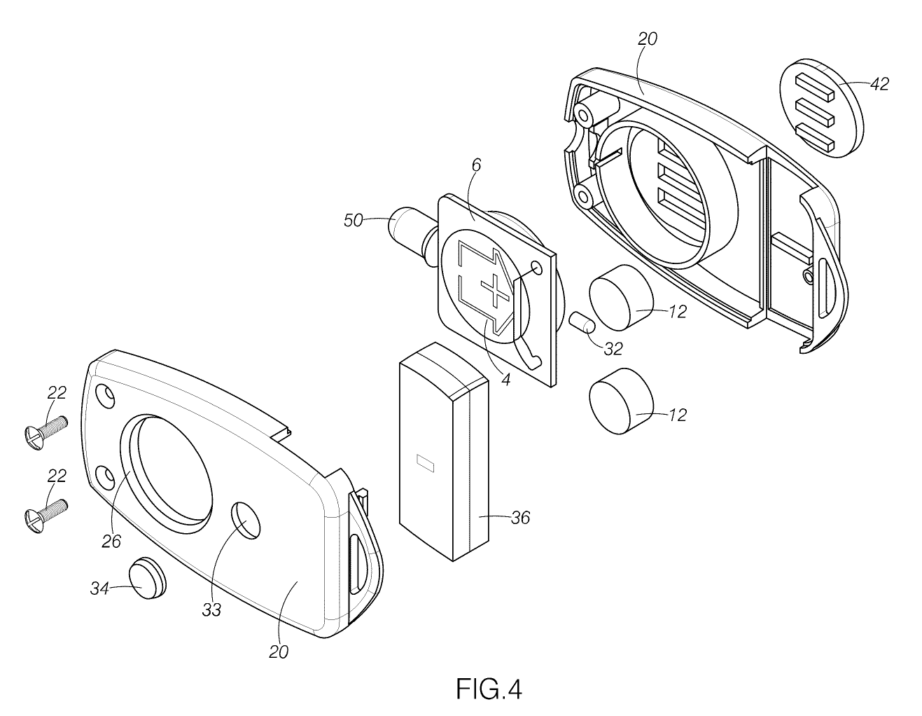

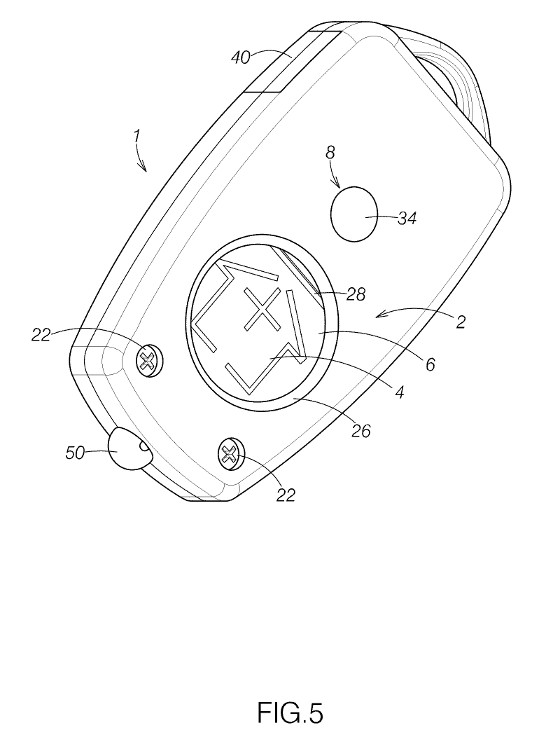

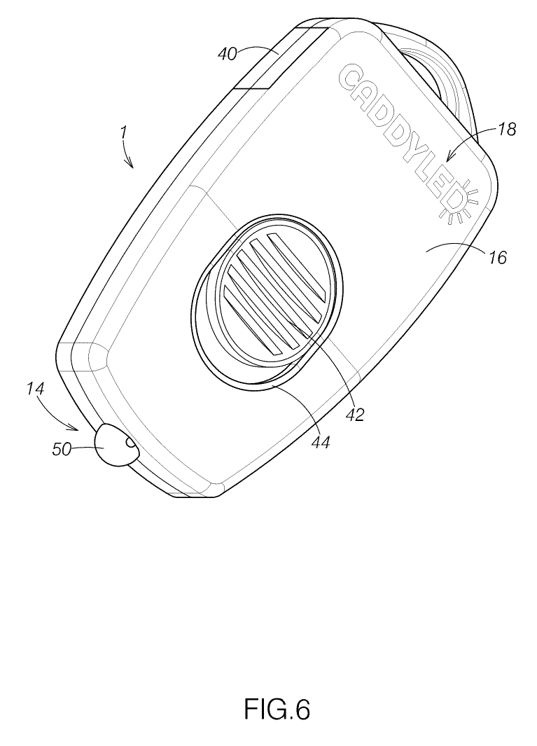

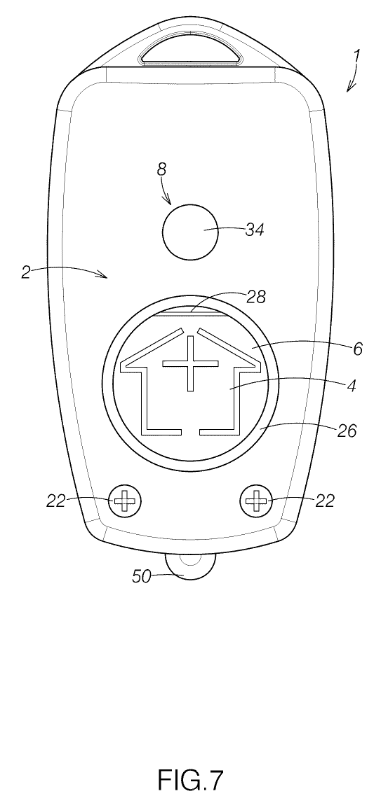

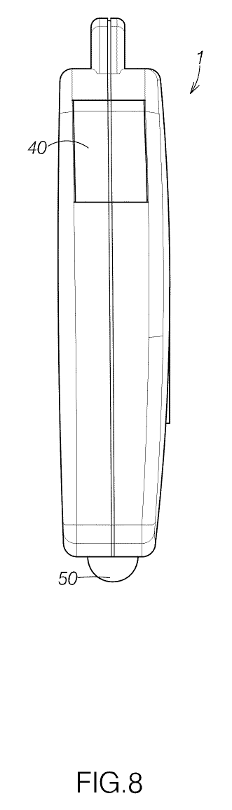

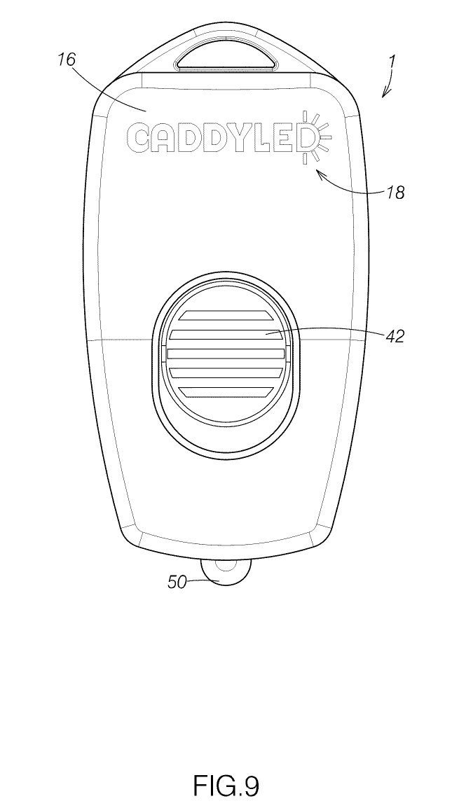

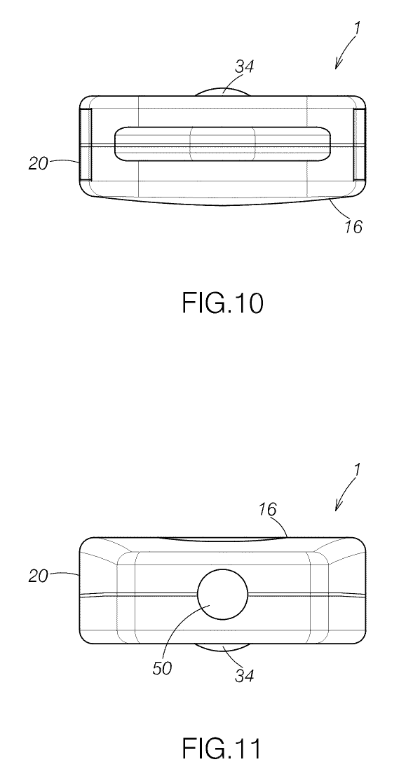

Representative embodiments according to the inventive subject matter are shown in FIGS. 1-11, wherein similar features share common reference numerals.

The following terms and definitions are used in the understanding of the prior art and the inventive subject matter. These definitions should be interpreted as broadly as possible in view of the inventive subject matter.

The inventive subject matter is directed to a caddy for testing hearing aid batteries, including a battery test unit having a battery receiver, a battery test mechanism, and an indicator mechanism showing the capacity of the battery tested. The caddy further includes a storage area, such as a compartment for storing hearing aid batteries. It may also include a flashlight, which may be used to help replace batteries in a hearing aid.

As used herein, the word “caddy” refers to a small container, such as a box, or other structure that supports the various elements mentioned above. For example, instead of a box the caddy could be a board-like structure with receptacles for receiving batteries to be stored and/or tested.

In the embodiment shown in FIGS. 1-11, the caddy 1 is formed of a casing 16 having two or more separate parts, namely a front side 18 and a back side 20. Front side 18 and back side 20 of the casing 16 may be held together by screws 22, for example by screws of 1.7×6 mm. However, any other suitable coupling elements, such as a snap-fit mechanism may be used. The casing 16 may be made of molded plastic, metal, or any other suitable material. As can be seen in the figures, the casing 16 may have a narrow elongated shape that allows for convenient handling and use of the caddy features. The dimensions of the caddy may be adapted for convenience of the user. For example, the caddy may be dimensioned to pocket size or key chain size. The casing 16 may further be provided with several openings and recesses to accommodate the different features of the caddy.

The front side 18 of the casing 16 is provided with a switch 42 for operating a flashlight 14. The back side 20 of the casing 16 has a receiver platform 4 for receiving a battery to be tested. Platform 4 allows the battery to connect with battery test unit 2 including a test mechanism 6 and an indicator mechanism 8 showing the battery test result.

FIGS. 1-5 and 7 illustrate how the casing 16 has an opening 26 forming a battery receiver, in the form of a platform 4 adapted to receive button-shaped batteries, as they are generally used in hearing aids. The battery receiver platform 4 is adapted to place button-shaped batteries with the plus side of the battery in the up position and allows for moving the battery to the edge of the circle to activate test mechanism 6. The battery receiver platform 4 may further be provided with symbols indicating the direction in which to slide the battery to activate the test mechanism. For example, an arrow may point towards the edge of the platform where the battery should touch to activate the test mechanism.

Test mechanism 6 tests the capacity of the battery and provides indicator mechanism 8 with a signal. As may be seen in FIGS. 1-4, test mechanism 6 may consist of a circular opening in the casing 16, a platform 4, a connector 28, and a printed circuit board 30 providing a signal to indicator mechanism 8. Indicator mechanism 8 uses this signal to display the test result by, for example, activating a light bulb 32. A window will show the status of the light bulb. Here, a circular opening 33 in the back side 20 of casing 16 is provided with a lens 34 to show the status of light bulb 32. When a user pushes a battery to the connector 28 of test mechanism 6, the cylindrical side of the battery will contact connector 28. This connection allows the printed circuit board to activate the light. A green light may appear in the window indicating that the battery is still charged.

A light bulb that does not light up indicates that the battery is no longer charged. In this case, light bulb is powered by the hearing aid battery that is being tested, thus allowing a signal when the battery is charged. In other embodiments, the indicator mechanism could display a range indicating the remaining capacity of the battery or the indicator mechanism may have one or more light sources, such as an LED, powered by the battery to be tested. For example different color lights or number of lights, correspond to a level of battery charge.

Additionally, a storage compartment 10 is located within casing 16 for storing hearing aid batteries 12. In this case, a drawer 36 having two slots 37 may fit within casing 16. The slots 37 of drawer 36 maybe dimensioned to hold, for example, two AG 5 batteries. However, the dimensions of the drawer may be adapted to hold hearing aid batteries of any size. As seen in FIG. 1, casing 16 may have projections or lips 38 holding the drawer in place in the center of the casing. Casing 16 has openings 40 on the sides allowing drawer 36 to be pushed out of casing 16. When pushing on one side of drawer 36, the drawer will appear at the opposite side of the casing allowing the battery to be removed. Projections 38 of casing 16 also act as a stopper allowing only one slot of the drawer to slide out of the casing and preventing the entire drawer from being pushed out.

A drawer center point 39 on the back side of drawer 36 may interact with projections 38 to hold the drawer in position within casing 16. The drawer and casing may be shaped to accommodate batteries in such a way that it allows for a battery to be removed from the drawer and inserted in a hearing device without touching the battery. New batteries may be inserted into the drawer and the drawer may be pushed back in place in the casing to allow storage of the batteries.

The casing may further contain a flashlight that may be operated from a switch on the outside of the front side of the casing. However, a flashlight maybe activated by any suitable means. FIGS. 1-4, 6, and 9 show a circular switch knob 42 positioned in an oval recess 44 at the front side 18 of casing 16. Switch knob 42 may be slid forward towards a stop point 46 whereby a stop hole 48 in switch knob 42 is engaged by a complementary protrusion in the recess. The flashlight may be turned on or off by sliding the switch 15 forward or backward. The light 50 may be a light emission diode, for example a 5 mm LED. The light 50 is operated by a battery 52, such as a 2016 battery used in the embodiment shown in FIG. 1. The different features of the caddy according to the embodiment described above maybe used as follows. The flashlight maybe turned on or off by sliding the switch 20 forward or backward. The battery test unit may be used by placing the hearing aid battery with the plus side of the battery in an up position inside of the circle and subsequently sliding the battery towards the edge of the circle, following the arrow at the bottom of the circle. A green light will come on if the battery is good. No light means battery needs to be replaced. The green light receives its power from the hearing aid battery that is being tested. A new battery may be taken out of the drawer when needed. In the embodiment described above, the drawer can hold two hearing aid batteries size 13, 312, and 10. To access the drawer a user can push on either side of the device and the drawer will slide 5 out exposing one compartment for one battery.

The inventive subject matter further contemplates a method for making and using such a caddy.

Persons skilled in the art will recognize that many modifications and variations are possible in the details, materials, and arrangements of the parts and actions which have been described and illustrated in order to explain the nature of the inventive subject matter, and that such modifications and variations do not depart from the spirit and scope of the teachings and claims contained therein.

All patent and non-patent literature cited herein is hereby incorporated by references in its entirety for all purposes.

1. A caddy for testing hearing aid batteries, comprising:
a battery test unit including a battery receiver, a battery test mechanism, and an indicator mechanism indicating the capacity of the battery tested; and
a storage compartment for storing hearing aid batteries.

2. The caddy of claim 1, wherein the caddy further includes a flashlight.

3. The caddy of claim 1, wherein the battery receiver is a platform adapted to receive one or more button-shaped batteries.

4. The caddy of claim 3, wherein the battery receiver is adapted to place button-shaped batteries with one particular terminal side in a particular direction, and
allowing for sliding the battery towards the battery test mechanism thereby activating the test mechanism and displaying a test result with the indicator mechanism.

5. The caddy of claim 1, wherein the battery receiver includes a symbol indicating the direction to slide the battery to activate the test mechanism.

6. The caddy of claim 1 wherein the indicator mechanism is a light emitting diode.

7. The caddy of claim 1, wherein the battery receiver includes a symbol indicating the direction in which to slide the battery to activate the test mechanism.

8. A caddy for testing hearing aid batteries, comprising:
a casing comprising a side having an opening for a battery receiver for receiving a hearing aid battery, the battery receiver allowing the battery to connect with a test mechanism that activates an indicator mechanism indicating the battery capacity;
a storage compartment for storing one or more hearing aid batteries; and
optionally a flashlight operable from a switch on the front side of the casing.

9. The caddy of claim 8, wherein the battery receiver is adapted to place one particular terminal side of a hearing aid battery in a particular direction,
such that the plus side of the battery is in the up position, and
allowing for sliding the battery towards the battery test mechanism,
thereby activating the battery test mechanism and activating the indicator mechanism.

10. The caddy of claim 8, wherein the opening for the battery receiver allows the battery to be tested to move to the edge of the opening to activate the test mechanism.

11. The caddy of claim 8, wherein the indicator mechanism comprises a light source powered by the battery to be tested.

12. The caddy of claim 11, wherein the casing further comprises a window showing the light source.

13. The caddy of claim 8, wherein the storage compartment comprises a slideable drawer dimensioned to store two button-shaped hearing aid batteries.

14. The caddy of claim 13, wherein the drawer is dimensioned to fit two AG 5 batteries.

15. The caddy of claim 8, wherein the flashlight comprises an LED and a battery.

16. A method for testing hearing aid batteries, comprising the steps of:
selecting a caddy, the caddy comprising a casing, the casing further comprising a side having an opening for a battery receiver for receiving a hearing aid battery, the battery receiver allowing the battery to connect with a test mechanism that activates an indicator mechanism indicating the battery capacity;
removing a battery from a caddy storage compartment, the storage compartment capable of storing one or more hearing aid batteries;
inserting the battery into the battery receiver, such that the battery receiver connects with indicator mechanism.

17. The method for testing hearing aid batteries as in claim 16 further comprising the steps of:
reading the indicator mechanism, the indicator mechanism having a light emitting diode, the light emitting diode being activated if the battery is operational;
disposing of the battery if the indicator mechanism is not activated.

18. The method for testing hearing aid batteries as in claim 16 further comprising the steps of:
sliding a switch knob, the switch knob being capable of activating a flashlight.
